(19) United States
(12) Patent Application Publication
(10) Pub. No.: US 2015/0355007 A1
(43) Pub. Date: Dec. 10, 2015

(54) APPARATUS, METHOD AND COMPUTER PROGRAM PRODUCT FOR ANALYZING FLUIDITY

(71) Applicant: KABUSHIKI KAISHA KOBE SEIKO SHO (KOBE STEEL, LTD.), Hyogo (JP)

(72) Inventors: Kazuhide SEKIYAMA, Kobe-shi (JP); Sayaka YAMADA, Kobe-shi (JP); Tomokazu NAKAGAWA, Tokyo (JP)

(73) Assignee: KABUSHIKI KAISHA KOBE SEIKO SHO (KOBE STEEL, LTD.), Hyogo (JP)

(21) Appl. No.: 14/716,720

(22) Filed: May 19, 2015

(30) Foreign Application Priority Data
Jun. 4, 2014 (JP) 2014-115452

(51) Int. Cl. G01F 1/708

(52) U.S. Cl. CPC G01F 1/708

(57) ABSTRACT

An apparatus, method and computer program product for analyzing fluidity are provided which enable fineness and coarseness in a particle distribution pattern in an object to be restrained in analysis results and thus, the fluidity analysis to be conducted with high accuracy. The apparatus for analyzing fluidity, using a particle method, determines a velocity of each particle, based on particle information of a position of each particle and a physical state of each particle in the last time step, and determines a position of each particle in the current time step, based on the velocity determined. The apparatus for analyzing fluidity next rearranges, based on distances between particles arranged at the determined positions, each particle in the current time step so that the fineness and coarseness in the particle distribution pattern in a target for analysis is reduced.

### CROSS-REFERENCE TO RELATED APPLICATIONS

This application is based upon and claims the benefit of priority from Japanese Patent Application No. 2014-115452, filed Jun. 4, 2014, the entire contents of which are incorporated herein by reference.

### BACKGROUND OF THE INVENTION

1. Field of the Invention

The present invention relates to apparatuses, methods and computer program products for analyzing fluidity of an object having fluidity using the particle method.

A method of analyzing a motion of an object is broadly classified into methods such as a differential method and a finite element method that employ fixed calculation grids; and a particle method that handles an object as congregated particles without using the calculation grids. The particle method enables analysis of a greatly deformed object, which is impossible to be conducted using a method that employs the fixed calculation grid. And the particle method serves a useful function in analysis of fluid such as to causes a droplet of the fluid.

2. Description of the Related Art

JP 2008-111675 A discloses a method of analyzing fluid using the particle method. In the method disclosed in JP 2008-111675 A, a provisional arrangement of particles is determined from a force exerted between particles in a certain time step, and using this provisional arrangement, a pressure in a next time step is calculated through calculation that makes a particle number density constant; corrected velocity of each particle is determined by calculation from a pressure gradient determined by calculation using the pressure; and using the velocity, the position of each particle is corrected.

### SUMMARY OF THE INVENTION

In a conventional fluidity analysis based on the particle method, there are found regions of finely and coarsely distributed particles in the analysis result. In JP 2008-111675 A, described above, the particle number density is defined as a sum of weight according to the inter-particle distance. The conditions that make the number density of such particles constant does not assure that the distances between the neighboring particles are made constant, and nor does the method described in JP 2008-111675 A clear fineness and coarseness in particle distribution pattern in the provisional arrangement. Once fine and coarse particle distributions occur, a problem is created in that the accuracy of analysis is lowered for an object such as a minutely compressible fluid in which the fine and coarse particle distributions do not substantially occur.

The present invention is devised in light of such circumstances, and an object of the invention is to provide apparatuses, methods and computer program products for analyzing fluidity, that enable the foregoing problems to be overcome.

In order to overcome the foregoing problem, an apparatus for analyzing fluidity according to one aspect of the present invention is an apparatus for analyzing fluidity that estimates a temporal change in a particle position in a target for analysis composed of particles, the apparatus for analyzing fluidity comprises a position determination unit that determines velocity of each particle, based on particle information of a position of each of the particles and a physical state of each particle in the last time step, and determines a position of each particle in the current time step, based on the determined velocity; and a rearrangement unit that rearrange each particle in the current time step so that fineness and coarseness in a particle distribution pattern in the target for analysis is reduced, based on a distance between particles arranged at positions determined by means of the position determination unit.

In this aspect, the rearrangement unit may be configured to rearrange each particle in the current time step in such a way that distances between neighboring particles are made uniform.

Further, in the above aspect, the rearrangement unit may be configured to estimate a change of each particle position due to force of a spring when the neighboring particles are assumed to be interconnected by means of the spring.

Still further, in the above aspect, the rearrangement unit may be configured to repeat calculations of the each particle position varied by the force of the spring until the amount of variation converges to a predetermined allowed value or less.

Yet further, in the above aspect, the apparatus for analyzing fluidity may further include a particle information acquisition unit that acquires, based on particle information of each particle before rearrangement, particle information of a physical state of a particle rearranged by means of the rearrangement unit.

Still yet further, in the above aspect, the target for analysis may be a minutely compressible fluid.

Further, a method of analyzing fluidity according to one aspect of the present invention is a method for fluid analysis that estimates a temporal change of a particle position in a target for analysis composed of particles, the method comprising determining a velocity of each particle, based on the position of each particle and the particle information of the physical state of each particle in the last time step; determining the position of each particle in the current time step, based on the velocity determined; and rearranging each particle in the current time step so that fineness and coarseness in a particle distribution pattern in the target for analysis is reduced, based on a distance between particles arranged at positions determined by means of the position determination unit.

Further, a computer program product according to one aspect of the present invention is a computer program product that causes a computer to estimate a temporal change of a position of a particle in a target for analysis composed of particles, the computer program product causing the computer to function as: a position determination unit that, based on particle information of a position of each of the particles and a physical state of each particle in a last time step, determines velocity of each particle, and based on the determined velocity, determines a position of each particle in a current time step; and a rearrangement unit that rearrange each particle in the current time step so that fineness and coarseness in a particle distribution pattern in the target for analysis is reduced, based on a distance between particles arranged at positions determined by means of the position determination unit.

The apparatus, method and computer program product for analyzing fluidity according to the present invention enables fine and coarse particle distribution patterns to be restrained in the analysis result and thus, the fluid analysis of an object to be conducted with high accuracy.

### BRIEF DESCRIPTION OF THE DRAWINGS

FIG. 1 is a block diagram illustrating an apparatus for analyzing fluidity according to one embodiment;

FIG. 2 is a flow diagram illustrating a procedure of a fluidity analysis process executed by the apparatus for analyzing fluidity according to one embodiment;

FIG. 3A is a schematic diagram for describing a rearrangement process of particles;

FIG. 3B is a schematic diagram for describing the rearrangement process of particles;

FIG. 3C is a schematic diagram for describing the rearrangement process of particles;

FIG. 3D is a schematic diagram for describing the rearrangement process of particles;

FIG. 4A is a schematic diagram for describing an acquisition process of particle information;

FIG. 4B is a schematic diagram for describing the acquisition process of particle information;

FIG. 5 is a schematic diagram for describing an analysis model for a problem of a double-wall cylinder problem in an evaluation test;

FIG. 6 is a view illustrating an analysis result, based on the conventional method, with regard to particle positions of material A after one revolution of an inner cylinder;

FIG. 7A is a graph illustrating a relationship between a circumferential velocity after the one revolution and a particle radial coordinate with regard to all the particles analyzed through the inventive method;

FIG. 7B is a graph illustrating a relationship between a circumferential velocity after one revolution and a particle radial coordinate with regard to all the particles analyzed through the conventional method;

FIG. 8 is a schematic diagram for describing a rotary experimental device and an analysis model for an evaluation test;

FIG. 9A is a view illustrating a result observed with the experimental device and an analysis result based on the inventive method;

FIG. 9B is another view illustrating a result observed with the experimental device and an analysis result based on the inventive method;

FIG. 9C is another view illustrating a result observed with the experimental device and an analysis result based on the inventive method;

FIG. 9D is another view illustrating a result observed with the experimental device and an analysis result based on the inventive method;

FIG. 9E is another view illustrating a result observed with the experimental device and an analysis result based on the inventive method; and

FIG. 10 is a set of views for comparison between the result observed with the experimental device, the analysis result based on the inventive method, and the analysis result based on the conventional method.

### DESCRIPTION OF THE EMBODIMENTS

An exemplary embodiment according to the present invention will be described hereinafter with reference to the drawings.

An apparatus for analyzing fluidity according to the present embodiment is an apparatus that simulates a motion of an object, which is a target for analysis, by means of particle method. In other words, with the target for analysis assumed to be composed of a plurality of particles, the apparatus for analyzing fluidity determines by calculation the position of each particle for each time step, based on particle motion equations. The target for analysis is a continuum that undergoes plastic deformation or that flows, or alternatively, an object that can be regarded as a continuum. Specifically, the object includes a resin, rubber, plastic, high viscous fluid of metal, etc. during casting, low viscous fluid such as water, solid such as a metal during casting and plastic deformation, and powder such as cement. It should be noted that in the description below, the target for analysis is assumed to be high viscous fluid, which is minutely compressible fluid.

Configuration of Apparatus for Analyzing Fluidity

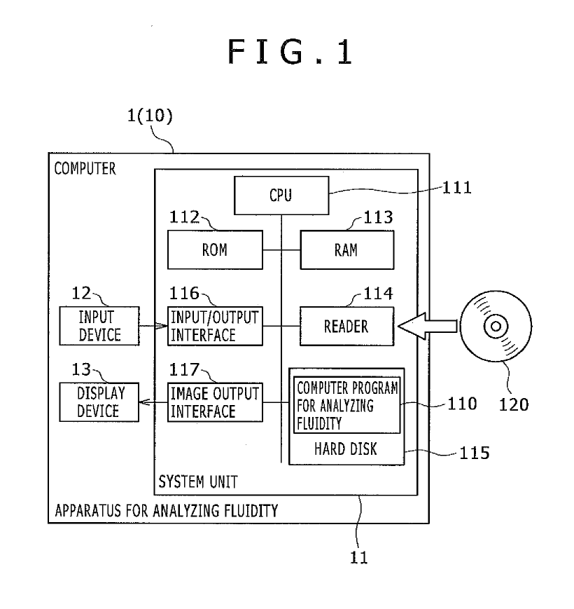

FIG. 1 is a block diagram illustrating a configuration of an apparatus for analyzing fluidity according to the present embodiment. An apparatus for analyzing fluidity, 1 is implemented by means of a computer 10. As shown in FIG. 1, the computer 10 includes a system unit 11, an input device 12 and a display device 13. The system unit 11 includes a CPU 111, a ROM 112, a RAM 113, a hard disk 115, a reader 114, an input/output interface 116, and an image output interface 117. The CPU 111, the ROM 112, the RAM 113, the hard disk 115, the reader 114, the input/output interface 116 and the image output interface 117 are interconnected by means of buses.

The CPU 111 enables executing a computer program product loaded into the RAM 113. And the CPU 111 executes a program instruction for use in fluidity analysis—computer program for analyzing fluidity, 110—thereby causing the computer 10 to function as the apparatus for analyzing fluidity 1.

The ROM 112 is composed of a memory device such as a mask ROM, PROM, EPROM or EEPROM; the computer program to be executed on the CPU 111 and data to be used for the program are stored in the ROM 112.

The RAM 113 is composed of a memory device such as a SRAM or a DRAM. The RAM 113 is used to read the computer program for analyzing fluidity 110 stored in the hard disk 115. When the CPU 111 executes the computer program, the RAM 113 is also utilized as a work area for the CPU 111.

The hard disk 115 is loaded with a variety of computer programs for causing the CPU 111 to execute, such as an operation system and application programs, and with data that are used to execute the computer programs. The computer program for analyzing fluidity 110 is also loaded in the hard disk 115.

Loaded in the hard disk 115 is, for example, an operating system such as Windows™ that is manufactured and sold from Microsoft Corporation, U.S. In the description below, the computer program for analyzing fluidity 110 according to the present embodiment is assumed to be operable on such an operating system.

The reader 114 is composed of a device such as a flexible disk drive, a CD-ROM drive, or a DVD-ROM drive, and can read the computer program or data stored in a portable recording medium 120. In addition, stored in the portable recoding medium 120 is the computer program for analyzing fluidity 110 for causing the computer to function as an apparatus for analyzing fluidity and thus, the computer 10 can read the computer program for analyzing fluidity 110 from the portable recording medium 120, to load the computer program for analyzing fluidity 110 into the hard disk 115.

The input/output interface 116 is composed of, for example, a serial interface such as USB, IEEE1394 or RS-232C; a parallel interface such as SCSI, IDE or IEEE1284; and interfaces such as analog interfaces that are made up of a D/A converter and A/D converter. The input device 12, composed of a keyboard and a mouse, is connected to the input/output interface 116, and the use of the input device 12 by a user enables entering data into the computer 10.

The image output interface 117 is connected to the display device 13 composed of a device such as an LCD or CRT, and is configured or designed to generate as an output to the display device 13 an image signal according to image data provided from the CPU 111. The display device 13 displays an image (screen image) in accordance with the input image signal.

Operation of Apparatus for Analyzing Fluidity

The operation of the 1 according to the present embodiment will be described hereinafter.

The apparatus for analyzing fluidity 1 executes a fluidity analysis process as will be described below, to simulate a motion of a target for analysis. The apparatus for analyzing fluidity 1 according to the present embodiment employs an Element-free Galerkin Method (EFGM), which is one of the particle methods, and performs fluidity simulations.

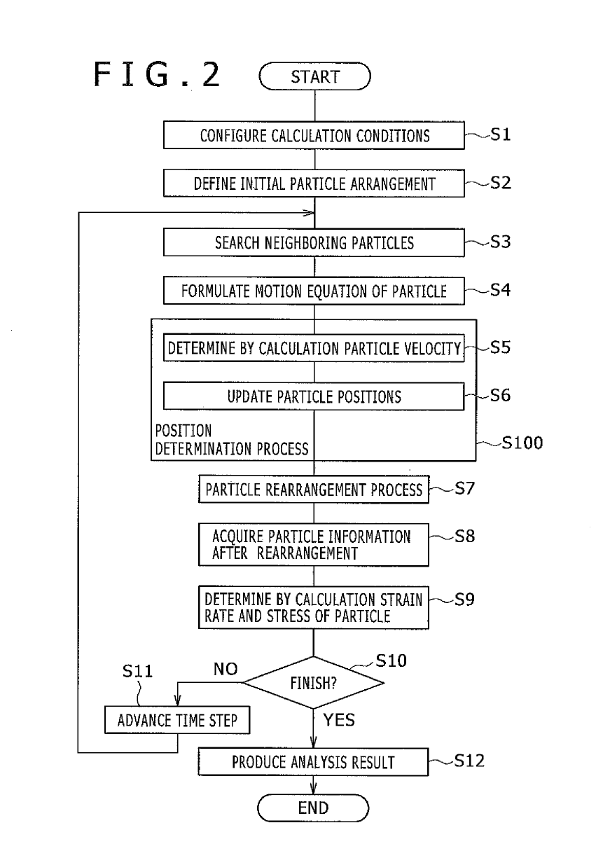

FIG. 2 is a flow diagram illustrating a fluidity analysis process performed by the apparatus for analyzing fluidity 1 according to the present embodiment.

In the fluidity analysis process, the CPU 111 first configures calculation conditions (step S1). In this process, various types of parameters are defined.

The CPU 111 next defines an initial particle arrangement (step S2). In the initial particle arrangement, the distances between neighboring particles are assumed to be equal. It should be noted here that in the initial particle arrangement, the distances between the neighboring particles may be unequal. This is because the process in step S7 as will be described later makes uniform the distances between the neighboring particles.

The CPU 111 next searches particles located in proximity of a particle of interest (step S3). In this process, the radius of an influence region is predetermined, which is a region where there exists particles having an effect on a motion of the particle of interest, and particles are searched that are included in the influence region around the particle of interest with the particle in the center. Having completed its search of particles in proximity of one particle of interest, the CPU 111 assigns a next particle of interest to search particles in its proximity. In this way, proximity particles are searched with respect to all particles.

Next, the CPU 111 formulates a motion equation of each particle (step S4). The motion equation of the particle will be described below.

Approximation of Field

In the present embodiment, moving least square (MLS) interpolation is employed for approximation of field. In the MLS, an amount Φ (x) in an arbitrary point x of a continuum is shown as the flowing equation.

Equation 1

φ(x)=N(x)Φ (1)

Here,

Equation 2

Φ^{T}=[φ₁ φ₂ . . . φ_{N}] (2)

N(x)=p^{T}(x)A⁻¹(x)B(x) (3)

Symbol ΦI denotes a value φ of particle point I, and N, the total particle count. P (x) is a base vector of a polynomial of m-th degree, and for example, when m=1 in the two dimensions, it becomes pT (x)=[1, x, y].

In addition,

$$\begin{matrix}• Equation 3 • & \\ A ( x ) = {\sum }_{I = 1}^{n} {w}_{I} ( x ) p ( {x}_{I} ) {p}^{T} ( {x}_{I} ) & ( 4 ) \\ B ( x ) = [ {w}_{1} ( x ) p ( {x}_{1} ) , … , {w}_{n} ( x ) p ( {x}_{n} ) ] & ( 5 )\end{matrix}$$

Symbol w_{I} is a weight function, and the following equation is employed here.

$$\begin{matrix}• Equation 4 • & \\ {w}_{I} ( x ) = \{ \begin{matrix}\frac{{e}^{- {α ( r / {r}_{0} )}^{2}} - {e}^{- α}}{1 - {e}^{- α}} , & r \leq {r}_{0} \\ 0 , & r > {r}_{0}\end{matrix} & ( 6 )\end{matrix}$$

where r=|x−xI|, α denotes a constant, and r0, a radius of the influence region. For example, when α=7, then r₀ can be made to be 2.6 times the initial particle intervals.

Discretization of Dominant Equation

### (1) Dominant Equation and Functional

In the present embodiment, a highly viscous substance having an Re number of 1.0 or less is a target. For this reason, the following dominant equation is employed in which inertial force is neglected.

Equation 5

∇·σ+b=0 in Ω (7)

n·σ= t̅ on Γₜ (8)

u=ū on Γᵤ (9)

where:
Ω=target region, Γₜ=surface force predetermined boundary,
Γᵤ=velocity predetermined boundary, σ=stress tensor,
b=body force vector, ∇=vector differential operator,
u=velocity vector, n=normal direction vector of boundary,
ū=boundary velocity vector, and t̅=surface force vector.

The following functional is defined with respect to Equation (7) through (9).

$$\begin{matrix} • Equation 6 • & \\ π ( u ) = {\int }_{Ω}^{ } ( \frac{1}{2} \dot{ɛ} ( u ) \text{:} σ ( u ) - u \cdot b ) d Ω - {\int }_{{Γ}_{t}}^{ } u \cdot \overline{t} d Γ + \frac{1}{2} κ {\int }_{{Γ}_{u}}^{ } ( u - \overline{u} ) \cdot ( u - \overline{u} ) d Γ & ( 10 )\end{matrix}$$

where \dot{ε} is a strain rate tensor.

Equation (10), the right side, third term is a penalty member that is introduced in order to satisfy the velocity boundary conditions, wherein κ is a very large number (which is set to 10¹⁰ in the present embodiment).

### (2) Discretization

The velocity at an arbitrary point x is expressed by the following equation using Equation (1).

$$\begin{matrix}• Equation 7 • & \\ u ( x ) = {\sum }_{I = 1}^{n} {N}_{I} ( x ) {\tilde{u}}_{I} & ( 11 )\end{matrix}$$

where:
N_{I}=I-th component of N vector, u=x-direction velocity, and
ũ_{I}=particle I velocity in the same direction (similar also in another direction).

Stationary conditions of the functional and Equation (11) yields the following equations.

$$\begin{matrix}• Equation 8 • & \\ K \tilde{u} = f & ( 12 ) \\ {K}_{IJ} = {\int }_{Ω} {B}_{I}^{T} {DB}_{J} d Ω + κ {\int }_{{Γ}_{u}}^{ } {N}_{I}^{T} {N}_{J} d Γ & ( 13 ) \\ {f}_{I} = {\int }_{Ω} {N}_{I} b d Ω + {\int }_{{Γ}_{t}} {N}_{I} \overline{t } d Γ + κ {\int }_{{Γ}_{u}}^{ } {N}_{I} \overline{u} d Γ & ( 14 )\end{matrix}$$

where ũ=particle velocity vector.

In Equations (13) and (14), suffixes I and J denotes the components associated with the particles I and J.

With respect to the two-dimensional problem, each matrix component is shown by the following equations.

$$\begin{matrix}• Equation 9 • & \\ {B}_{I} = [ \begin{matrix}{N}_{I , x} & 0 \\ 0 & {N}_{I , y} \\ {N}_{I , y} & {N}_{I , x}\end{matrix} ] & ( 15 ) \\ {N}_{I} = [ \begin{matrix}{N}_{I} & 0 \\ 0 & {N}_{I}\end{matrix} ] & ( 16 ) \\ D = [ \begin{matrix}4 μ / 3 + λ & - 2 μ / 3 + λ & 0 \\ - 2 μ / 3 + λ & 4 μ / 3 + λ & 0 \\ 0 & 0 & μ\end{matrix} ] & ( 17 )\end{matrix}$$

where μ is a viscosity coefficient, and λ is a volume compressibility coefficient.

Although λ=∞ for non-compressible fluid, it was set to λ=100μ in the present embodiment, assuming that the minutely compressible fluid is employed. A rocking phenomenon, which is in many cases a problem in such a minute compressibility problem, was not created in an evaluation test to be described later.

Further, when the weight function of Equation (6) is employed, the value of particle point is not one and the same as the interpolation value (φ(xI)≠φI); however, the penalty terms of Equation (13) and (14) can cause the boundary velocity that is calculated using Equation (11) to agree with the predetermined velocity.

### (3) Integration Method

In general, the EFGM requires a cell for numerical integration, thus resulting in this being a cause to increase the calculation load. For this reason, the integration point count was made to agree with the particle point count (nodal integration), thereby eliminating the need for the integration cell. In this case, Equations (13) and (14) are as given below.

$$\begin{matrix} • Equation 10 • & \\ {K}_{IJ} ≅ {\sum }_{a}^{Ω} {{B}_{I} ( {x}_{a} )}^{T} D ( {x}_{a} ) {B}_{J} ( {x}_{a} ) {V}_{a} + κ {\sum }_{a}^{{Γ}_{u}} {{N}_{I} ( {x}_{a} )}^{T} {N}_{J} ( {x}_{a} ) {S}_{a}^{u} & ( 18 ) \\ {f}_{I} ≅ {\sum }_{a}^{Ω} {N}_{I} ( {x}_{a} ) b ( {x}_{a} ) {V}_{a} + {\sum }_{a}^{{Γ}_{t}} {N}_{I} ( {x}_{a} ) \overline{t} ( {x}_{I} ) {S}_{a}^{t} + κ {\sum }_{a}^{{Γ}_{u}} {N}_{I} ( {x}_{a} ) \overline{u} ( {x}_{a} ) {S}_{a}^{u} & ( 19 )\end{matrix}$$

where Va denotes a volume of particle a, and Sa^{U} and Sa^{t}, respective areas on Γᵤ and Γₜ of the particle a. The Va was calculated based on the assumption that initial particles were arranged with equal spacing. It should be noted here that although process for restraining pressure vibrations generated with nodal integration is not performed, the process may be performed (refer to Beissel, S. et al.: Nodal integration of the element-free Galerkin method, Computer Methods Appl. Mech. Engrg., Vol. 139, pp 49-74, 1996).

Referring now back to the description of FIG. 2, after the process of step S4 has been executed, the CPU 111 determines by calculation the particle velocity (step S5). In the present embodiment, the particle velocity is calculated from the full implicit method and the second order Runge-Kutta method was used to update the particle coordinates. The process of step S5 will be described in detail.

A particle velocity vector is first defined as shown by the equation below, and an interpolation velocity Ut is calculated from Equation (11).

ũₜ=K(Xₜ,t)⁻¹f(Xₜ,t) Equation 11

where X denotes a particle coordinate vector, and suffix t, a value at time t.

Next, a particle coordinate vector after the time Δt/2 is determined by calculation from the following equation.

$$\begin{matrix}• Equation 12 • \\ {X}_{t + Δ t / 2} = {X}_{t} + \frac{1}{2} Δ t {U}_{t}\end{matrix}$$

where Δt denotes a time interval width, in other words, when t is assumed to be the last time step, then the current time step is t+Δt.

The particle velocity vector at time t+Δt/2 is given by the equation below.

$$\begin{matrix}•Equation 13 • & \\ {\tilde{u}}_{t + Δ t / 2} = {K ( {X}_{t + Δ t / 2} , t + \frac{1}{2} Δ t )}^{- 1} f ( {X}_{t + Δ t / 2} , t + \frac{1}{2} Δ t ) & \end{matrix}$$

From Equation (11), interpolation velocity at the particle point, Ut+Δt/2, is calculated.

After the particle velocity has been determined by calculation as in the foregoing, the CPU 111 determines by calculation the particle position in the current time step, to update the particle position (step S6). A particle position at time t+Δt is given by the following equation.

X_{t+Δt}=Xₜ+ΔtU_{t+Δt/2} Equation 14

In situations where μ is strain rate-dependent, after the process of step S6 has been completed, the strain rate is calculated to correct μ, and it will suffice if without advancing the time step, the process is returned to step S5 to repeat calculations until the change of μ is below the allowed value. In place of performing the repetitive calculations, an alternative method may be used in which a sufficiently small Δt is selected, and μ for the strain rate at a time before Δt is used as an approximate value.

Processes of steps S1 through S6 described above are those implemented by means of EFGM. Further, the processes of steps S5 through S6 represent a position determination process S100 (refer to FIG. 2) in which the velocity of each particle is determined from the position Xₜ of each particle at the last time step t and from particle information (velocity, pressure, temperature, stress, mass, volume, density, etc.) associated with physical state of each particle, and in which the position of each particle at the current time step t+Δt is determined using the determined velocity.

The position of each particle acquired in the above position determination process S100 causes fineness and coarseness in the distribution pattern of particles in the target for analysis, in other words, the intervals between neighboring particles are in some cases not made uniform. For that reason, the CPU 111 rearranges particles so as to reduce such fineness and coarseness in the particle distribution pattern (step S7). In this process, the particles are rearranged so that the volume of a target for analysis will not be varied before and after their rearrangement.

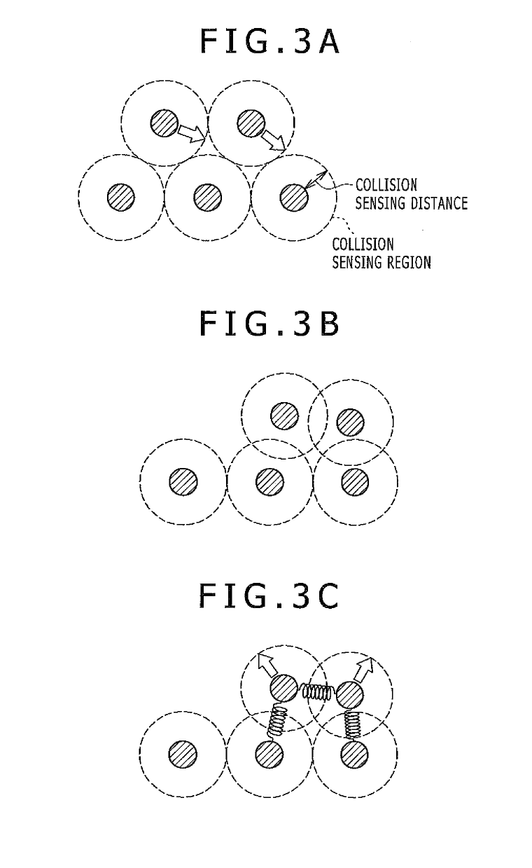

The process of step S7 will be described. FIG. 3A through FIG. 3D are schematic diagrams for describing the process of rearranging the particles. FIG. 3A illustrates one example of particle positions before updating the positions; FIG. 3B illustrates the particle positions updated from the state of FIG. 3A. In addition, FIG. 3C illustrates the concept of a process of rearranging the particles from the state of FIG. 3B. FIG. 3D illustrates the positions of the particles rearranged from the state of FIG. 3B.

As shown in FIG. 3A, the intervals between the neighboring particles are uniform before updating the particle positions. In other words, a circle-shaped collision sensing region is defined around each particle with the particle in the center, and the collision sensing regions for the neighboring particles are in contact with each other, so that two or more collision sensing regions will not overlap with each other, nor will the collision sensing regions be separated from each other. The distance from the particle surface to the outer circumference of the collision sensing region is designated as a collision sensing distance.

From the state of FIG. 3A, each particle is moved at the particle velocity determined by calculation, and the particle position is thereby updated into the state as shown in FIG. 3B. In FIG. 3B, as a result of each particle being moved closer together, the collision sensing regions for a plurality of particles overlaps, in other words, the distance between the neighboring particles is shorter than two times the collision sensing distance. Further, FIG. 3B shows the situation in which the distance between the neighboring particles is shorter than two times the collision sensing distance; however, in some cases, the distance between the neighboring particles is greater than two times the collision sensing distance.

After the particle positions have been updated, the neighboring particles are assumed to be connected together by means of a spring. The natural length of this spring is designed to be two times the collision sensing distance. In other words, when the spring has the natural length, the distance between the neighboring particles is two times the collision sensing distance. As shown in FIG. 3C, when the distance between the neighboring particles is shorter than two times the collision sensing distance, the spring that couples these particles together is shortened in length than the natural length, thus causing repulsive force to act on these particles to separate them from each other. Further, when the distance between the neighboring particles is greater than two times the collision sensing distance, these particles are assumed not to be in collision and accordingly, it is assumed that no inter-particle force is present. However, when fluid is employed in which the inter-particle attraction is not negligible, attraction is caused to act between these particles to cause the particles to come closer together. In addition, the above motion model of the spring has a damping factor included therein.

With the motion model of spring having the damping factor included therein, the distance between the neighboring particles approaches to two times the collision sensing distance when adjustments of inter-particle distances are repeatedly made by means of the spring. When the difference between the distance between the neighboring particles and two times the collision sensing distance is below the allowed value, the CPU 111 finishes the process of rearrangement of the particles. As a result of this, as shown in FIG. 3D, the collision sensing regions of the neighboring particles will not overlap with and separate from each other, and they are in contact with each other. In other words, the distances between the neighboring particles become uniform, and the fine and coarse particle distribution is cleared.

It should be noted that “make the distances uniform” as referred to herein means not only that distances between neighboring particles are constant, but that even though there exist errors in numerical calculations, or variations in the above allowed value and the like, the inter-particle distances are substantially equal.

The rearrangement process of the particles will be further specifically described. Their rearrangement process is performed in the procedures below.

The CPU 111 first performs an initial setting of article velocity and particle positions by means of the following equation.

û=0, Xᵢ₌₀=Xₜ Equation 15

Next, the CPU 111 calculates force Q acting on the particles by the following equation.

$$\begin{matrix}•Equation 16 • & \\ {Q}_{I} = {\sum }_{J = 1}^{n} {q}_{IJ} \frac{{x}_{J} - {x}_{I}}{\vert {x}_{J} - {x}_{I} \vert} \\ {q}_{IJ} = \{ \begin{matrix}k {δ}_{IJ} , & {δ}_{IJ} < 0 \\ 0 , & {δ}_{IJ} \geq 0\end{matrix} \\ {δ}_{IJ} = \vert {x}_{J} - {x}_{I} \vert - {s}_{0} & \end{matrix}$$

where Q_{I}=I-th component of Q.

Next, the CPU 111 updates the particle velocity and the particle position by the following equation.

û _{t̅+Δ t̅}=û _{t̅}+Δ t̅(Q−cû _{t̅})

X _{t̅+Δ t̅}=X _{t̅}+Δ t̅u _{t̅+Δ t̅} Equation 17

The step of determining by calculation the above force Q acting on the particle and the step of updating the particle velocity and the particle position are executed repeatedly until the variation of X is equal to or falls below the allowed value.

According to the above rearrangement process of the above particles, when distances between particles are s0 or less, repulsive force is exerted, resulting in equally spaced arrangement with a distance between particles of s0 after a given number of repetitions of the process. It should be noted that since symbols k, c, Δt have no physical meaning, they can freely be set so as to reduce the repetition count.

Referring now back to the description of FIG. 2, after the above rearrangement process of particles, the CPU 111 acquires particle information after their rearrangement.

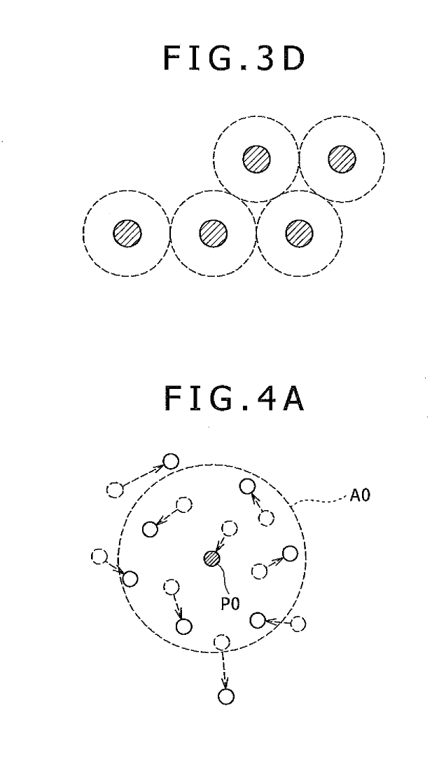

The process of step S8 will be described. FIG. 4A and FIG. 4B are schematic diagrams for describing an acquisition process of the particle information. FIG. 4A illustrates rearranged particles, with FIG. 4B showing the concept of the acquisition process of the particle information.

In FIG. 4A, circles in bold lines indicate particles after their rearrangement and circles in dotted lines indicate particles before their rearrangement. A particle with an oblique line in the figure is assumed to be a particle of interest, PO. A circle-shaped influence region AO is defined around the particle of interest PO with the particle in the center. The particle information (velocity, pressure, temperature, stress, mass, volume, density, etc.) of this particle of interest PO is contemplated to be influenced by each particle existed within the influence region AO before its rearrangement.

FIG. 4B shows the positions of the particles PP before their rearrangement, and the position of the particle PO after its rearrangement. Based on the particle information of the particles PP (shown shaded in the figure) existing within the influence region AO, the particle information of the particle of interest PO is determined by calculation by means of the following equation.

$$\begin{matrix}•Equation 18 • & \\ {Φ}_{P 0} = {\sum }_{PP} W ( r ) \cdot {Φ}_{PP} & \end{matrix}$$

where W denotes a weight function and Φ, particle information such as velocity, pressure, etc.

When the acquisition process of the particle information after the rearrangement, has finished, the CPU 111 calculates particles' strain rates and stresses (step S9). In this process, the particle strain rate can be calculated by means of the following equation.

$$\begin{matrix}•Equation 19 • & \\ {ɛ}_{i , j} = \frac{1}{2} ( {u}_{i , j} + {u}_{i , j} ) i , j = 1 ∼ 3 & \end{matrix}$$

where ε_{i,j} denotes a strain rate, and u_{i,j}, u_{j,i} denotes a rate gradient. Further, the particle stress can be calculated by multiplying the acquired strain rate by a viscosity coefficient.

It should be noted that the processes of the above step S7 through step S9 do not need to be executed for each time step. In situations where the position of each particle determined in the position determination process S100 has moved only a distance less than the predetermined value from the position at the last time step, and where the movement amount of particle is evaluated to be small, then the processes of steps S7 through S9 do not need to be executed. This allows for restraints of the calculation time without loss of the accuracy of analysis; however, in situations where more accurate analysis is desired, the analysis can be configured such that the processes of step S7 through S9 are executed for each time step.

Next, the CPU 111 determines whether the fluidity analysis process is finished (step S10), and if the fluidity analysis process is not finished (NO at step S10), then the time step is advanced by one (step S11) to proceed the process to step S3. Hereinafter, the CPU 111 repeats the processes of step S3 through S11 until the fluidity analysis process is determined to be finished. As a result of this, a temporal change of particle positions and particle information are simulated to acquire particle positional information and particle information on a time-series basis.

In step S10, when the fluidity analysis process is finished (YES at step S10), the CPU 111 provides output analysis results to the display device 13 (step S12), and then the fluid analysis process is finished. The analysis results to be displayed include images where a particle positions in a certain time step are rendered in coordinate space, numerical data of particle information, or the like. Further, images having the particles positions rendered in coordinate space are lined up on a time-series basis, or are screen transitioned on a time-series basis and thereby, the temporal changes of particle positions can be provided to a user in an easy-to-understand fashion.

With the apparatus being configured as described above, the apparatus for analyzing fluidity 1 according to the present embodiment can acquire analysis results that, with fine and coarse particle distribution being reduced, are close to a more actual motion of an object.

Further, the apparatus for analyzing fluidity 1 according to the present embodiment can be utilized to analyze behaviors of various objects, such as a behavior of e.g., synthetic resin or rubber during kneading, a behavior of e.g., plastic during injection molding, a behavior of a metal during casting or forging, a behavior of a metal during plastic deformation, and a behavior of a water-like, low viscous fluid.

### (Evaluation Test)

The apparatus for analyzing fluidity which has been described in the above embodiment was actually fabricated, and its performance was evaluated.

### (1) Test 1

The inventors conducted a test for calculating a stationary solution when, with a viscous fluid being filled within a double-wall cylinder, the inner cylinder is rotated at an angular velocity of ω0.

In this test, a viscous coefficient was used which was in accordance with a power law as shown by the following equation.

μ=μ₀\dot{γ}^{α-1} Equation 20

where \dot{γ}=shear strain rate, and μ₀, α=coefficient.

NS equations in cylindrical coordinate system having inertial force terms removed is solved under boundary fixation conditions by taking into consideration only the circumferential component of flow velocity, and then the following solution is yielded.

$$\begin{matrix}•Equation 21 • & \\ u ( r ) = {ω}_{0} ξ R \frac{{( R / r )}^{a} - r / R}{{ξ}^{- a} - ξ} ( a = \frac{2}{α} - 1 ) & ( 20 ) \\ τ ( r ) = {{μ}_{0} [ ( a + 1 ) {( R / r )}^{a + 1} \frac{ξ {ω}_{0}}{{ξ}^{- a} - ξ} ]}^{α} & ( 21 ) \\ T = 2 {π ( ξ R )}^{2} τ ( ξ R ) & ( 22 )\end{matrix}$$

where u denotes a circumferential velocity; τ, shear stress; r, a radial coordinate; R, an outer radius; ξ, a ratio of an inner cylinder radius to an outer cylinder radius; and T, torque acting on an inner cylinder (outer cylinder).

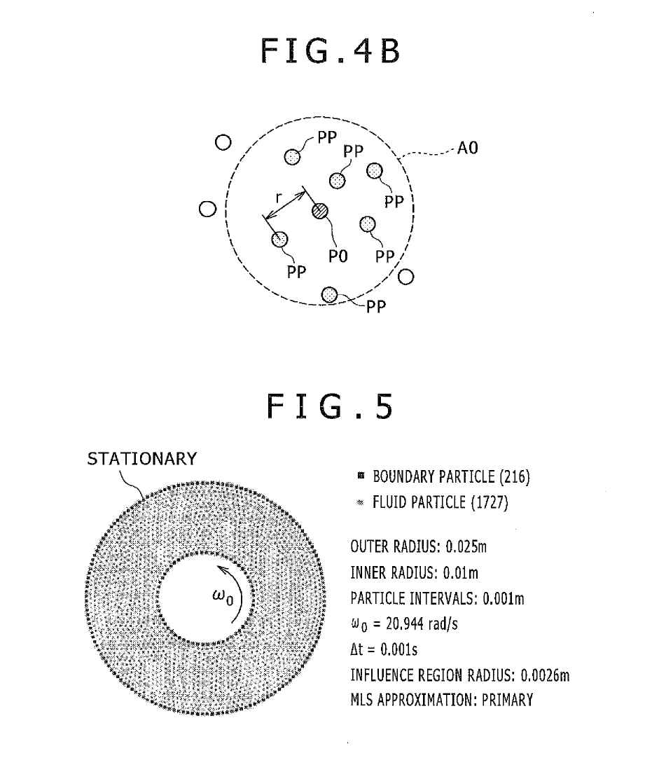

FIG. 5 is a schematic diagram for describing an analysis model of the double-wall cylinder problem in the present test. FIG. 5 shows initially arranged particles. In this initial arrangement, the intervals of neighboring particles are made uniform. It should be noted that FIG. 5 also indicates analysis conditions.

In this test, the following materials were selected.

### Material A: μ0=1000 Pa·s, α=1.0

### Material B: μ0=11324.76 Pa·s, α=0.3

In the case of this problem, the particle circumferential velocity needs to be in agreement with Equation (20), independent of positions in the circumferential direction or of times; however, in actuality, errors build up with moving particles. For this reason, in order to evaluate the errors, results after one revolution of the inner cylinder were obtained with respect to the inventive method and the conventional method (conventional analysis method based on EFGM), and both results were compared.

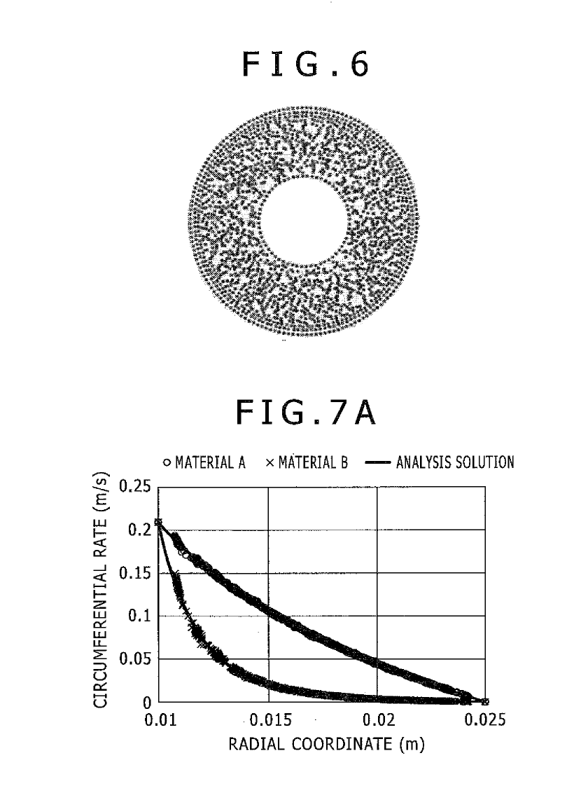

FIG. 6 is a view illustrating the analysis result, based on the conventional method, of particle position after one revolution of the inner cylinder of the material A. As shown in FIG. 6, the analysis result based on the conventional method indicates that the particle rearrangement is greatly out of order as compared with the initial one, and clustering of particles occurs. On the other hand, the inventive method indicated that the particle distribution after one revolution of the inner cylinder was generally uniform as with that of FIG. 5.

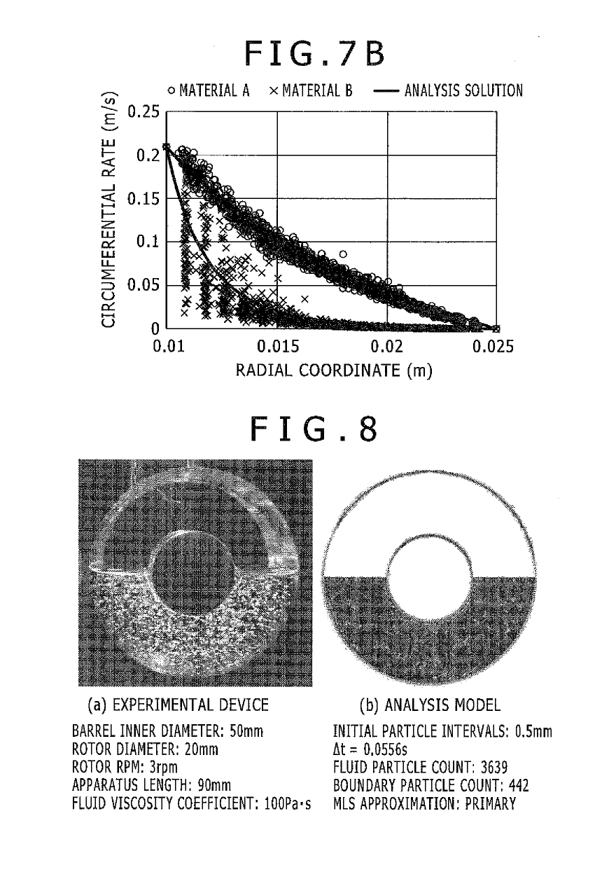

FIG. 7A and FIG. 7B each indicate a relationship between a circumferential velocity after one revolution and a particle radial coordinate with regard to all the particles analyzed. FIG. 7A indicates the result based on the inventive method, while FIG. 7B indicates the result based on the conventional method. FIG. 7A and FIG. 7B shows that the results based on the inventive method are in good agreement with the analysis results acquired through strict numerical calculations (hereinafter called “analysis solution”), while the results based on the conventional method includes great variations. In particular, the material B (non-Newtonian fluid) has such a strong tendency toward variations.

The following table shows comparison results of torque after one revolution. It should be noted here that the inventive method is compared with the conventional method using errors with respect to analysis solutions.

TABLE 1

| | Inventive | Conventional |
|---|---|---|
| | method | method |
| Material A | −0.6% | −26.5% |
| Material B | −0.3% | −0.6% |

Torque was calculated from boundary particle force of the following equations.

Equation 23

R_{I}=κ{U_{I}−ū(x_{I})} (23)

where R_{I} denotes a force acting on a particle I on the boundary; and U_{I}, interpolation velocity calculated by means of Equation (11).

The above table shows that in the inventive method the torque has an error of 1% or less with respect to the analysis solution. Further, the table given below indicates results of investigating influences on torque at initial particle intervals in the inventive method. The table below shows that in the inventive method, accuracy is maintained even in fairly coarse arrangement, such as in particle intervals of 4 milli-meters (the order of four particles in a transverse direction relative to a flow passage).

TABLE 2

Particle intervals (milli-meters)

| | 1 | 2 | 4 | 6 |
|---|---|---|---|---|
| Errors | −0.6% | −1.8% | −0.3% | −8% |

### (2) Test 2

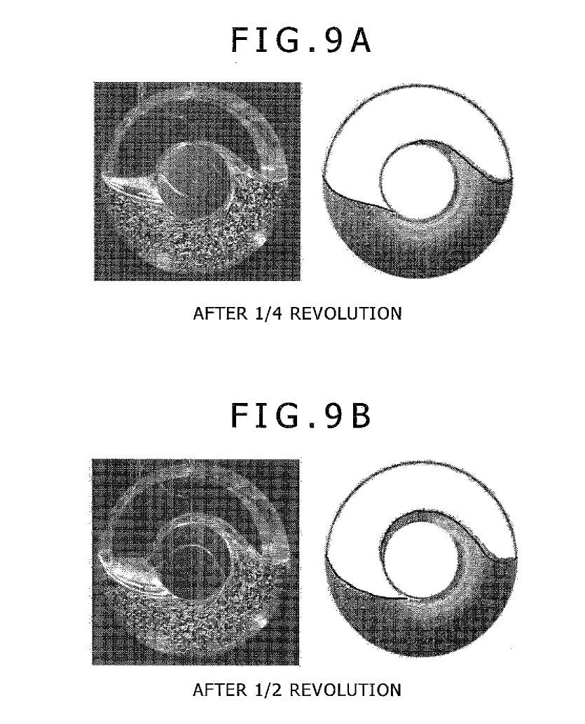

After silicon oil was filled in a rotary experimental device composed of a cylindrical barrel and a cylindrical rotor as shown in FIG. 8, the inventors made a video observation of its behavior with the cylindrical rotor rotated. Further, the inventors analyzed a similar analysis model based on the inventive method and the conventional method, and compared the video observed, actual fluid motion with those of the analysis results. It should be noted that FIG. 8 indicates the analysis conditions as well.

The viscosity coefficient of silicon oil is generally 100 Pa·s at a shear strain rate of 50 s⁻¹ or less at ambient temperature. In the experiment, many air bubbles are observed within the fluid, but it has been verified that from the comparison with the experiment of less air bubbles, there is almost no influence on the shape of fluid free surface of a bubble.

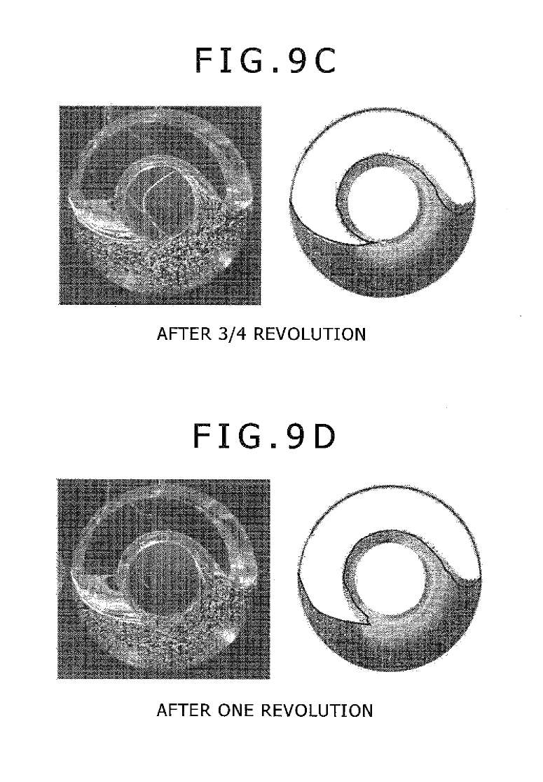

FIG. 9A through FIG. 9E are views each illustrating results observed with the experimental device and the analysis results based on the inventive method. FIG. 9A shows the result after ¼ revolution; FIG. 9B, the result after ½ revolution; FIG. 9C, the result after ¾ revolution; FIG. 9D, the result after one revolution; and FIG. 9E, the result after 3 revolutions.

It should be noted that in the analysis results of the inventive method in FIG. 9A through FIG. 9E, the free surface shape obtained from the video observation with the experimental device is shown in black solid line. As seen from the figures, there are slight differences between the analysis results based on the inventive method and the observation results such that the former results have somewhat more volume of fluid than the later results in the neighborhood where the fluid wound around the rotor joins with the lower portion of the fluid after one revolution; however, both results are generally in agreement with each other. It should be noted that the calculation time required for the present analysis was 528 seconds per revolution (using CPU: Intel Core™ i5-3210M, 2.5 GHz, 1 core).

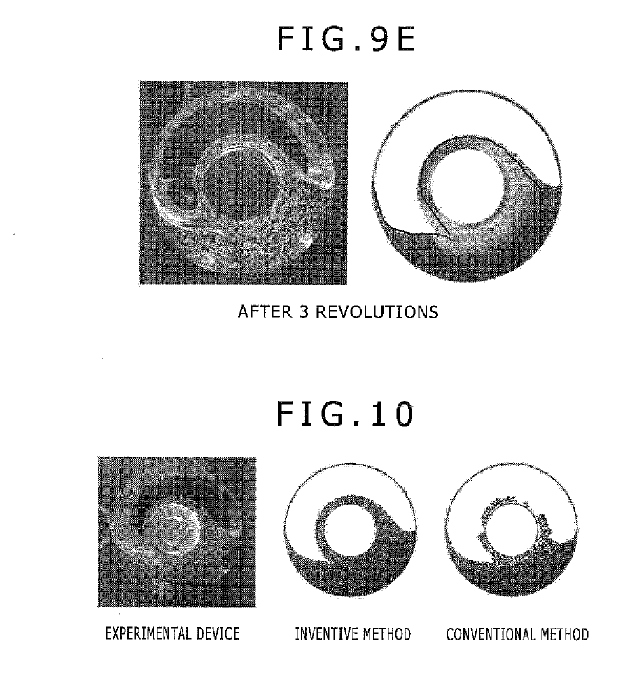

FIG. 10 is a set of views for comparison between the result observed with the experimental device, the analysis result based on the inventive method, and the analysis result based on the conventional method. FIG. 10 illustrates the results resulting from the rotor being rotated one revolution. It is seen from FIG. 10 that the particle distribution is uniform in the analysis result based on the inventive method, and the free surface shape is in good agreement with that of the observation result. On the other hand, the conventional method creates the fineness and coarseness in the particle distribution pattern. As a result, there is a lack of fluid around the rotor, and the free surface shape is not in agreement with that of the observation result.

### Other Embodiments

It should be noted that the foregoing embodiment describes the configuration in which after the positions of particles are updated, the particles are rearranged so that the intervals between neighboring particles are made uniform, but the invention is not limited to this configuration. Even if it is not mentioned that the intervals between neighboring particles are made uniform, the particles can be configured to be rearranged so that the fineness and coarseness in a particle distribution pattern may be reduced. For example, in the rearrangement process of particles, an allowed value for the difference of the distance between neighboring particles from two times the collision sensing distance is made comparatively great, so that restriction of the distance between the neighboring particles can be relaxed. By thus doing, the repeat count of adjusting the inter-particle distance can be restrained and the calculation time of fluidity analysis process be restrained while sufficient accuracy is maintained in the analysis results. Further, this also enables analysis of a high compressible material such as powder.

Further, the foregoing embodiment has described the configuration in which in the rearrangement of particles, the motion model of spring is utilized, but the invention is not limited to this configuration. A template for particle arrangement in which the intervals between neighboring particles are made constant is beforehand provided, and after the particle positions have been updated, the template is applied to a region where the updated particles exist, to make particle replacements, whereby the particles can be rearranged. It should be noted that “rearrangement of particles” as referred to herein means not only that the positional relationship of each particle is varied with the relationship between particles maintained before and after the process, but that the positional relationship of each particle is varied by replacing a particle before the process with a new particle, without matching the former particle to the latter particle.

Still further, the foregoing embodiment has described the configuration in which a particle information acquisition process is executed after the rearrangement process of particles, and the particle information of the particle of interest is determines by calculation, based on the particle information of each particle that has existed before the rearrangement, within the influence region of the particle of interest; however, the invention is limited to this configuration. The particle information acquisition process can also be removed. In this case, it will suffice if the repetitive time interval Δt for adjustment of an inter-particle distance in the rearrangement process of the particles is set to a sufficiently small value and adjustments of the distance between particles are made finely, and thereby the coordinate variation of particle at a single time adjustment is made small to achieve the accuracy of particle information.

Yet further, the foregoing embodiment has described the configuration in which in the fluidity analysis process, the velocity of each particle is determined by using EFGM, and the position of each particle is determined using the determined velocity; however, the invention is not limited to this configuration. The apparatus can also be configured such that by utilizing a method such as moving particle semi-implicit (MPS) or smoothed particle hydrodynamics (SPH), which is a particle method different from EFGM, the velocity of each particle is determined and the position of each particle is determined using the determined velocity.

### REFERENCE NUMERALS

1 Apparatus for analyzing fluidity
10 Computer
11 System body
12 Input device
13 Display device
110 Fluidity analysis program
111 CPU
112 RAM
113 ROM
115 Hard disk
116 Input/output interface
117 Image output interface
120 Portable recording medium

What is claimed is:

1. An apparatus for analyzing fluidity that estimates a temporal change in a particle position in a target for analysis composed of particles, the apparatus for analyzing fluidity comprising:
a position determination unit configured to determines velocity of each particle, based on particle information of a position of each of the particles and a physical state of each particle in the last time step, and determines a position of each particle in the current time step, based on the determined velocity; and
a rearrangement unit configured to rearrange each particle in the current time step so that fineness and coarseness in a particle distribution pattern in the target for analysis is reduced, based on a distance between particles arranged at positions determined by means of the position determination unit.

2. The apparatus for analyzing fluidity according to claim 1,
wherein the rearrangement unit is configured to rearrange each particle in the current time step in such a way that distances between neighboring particles are made uniform.

3. The apparatus for analyzing fluidity according to claim 1,
wherein the rearrangement unit is configured to estimate a change of each particle position due to force of a spring when the neighboring particles are assumed to be interconnected by means of the spring.

4. The apparatus for analyzing fluidity according to claim 2,
wherein the rearrangement unit is configured to estimate a change of each particle position due to force of a spring when the neighboring particles are assumed to be interconnected by means of the spring.

5. The apparatus for analyzing fluidity according to claim 3,
wherein the rearrangement unit is configured to repeat calculations of the each particle position varied by the force of the spring until the amount of variation converges to a predetermined allowed value or less.

6. The apparatus for analyzing fluidity according to claim 4,
wherein the rearrangement unit is configured to repeat calculations of the each particle position varied by the force of the spring until the amount of variation converges to a predetermined allowed value or less.

7. The apparatus for analyzing fluidity according to claim 1, further comprising:
a particle information acquisition unit that acquires, based on particle information of each particle before rearrangement, particle information of a physical state of a particle rearranged by means of the rearrangement unit.

8. The apparatus for analyzing fluidity according to claim 1,
wherein the target for analysis is a minutely compressible fluid.

9. A method of analyzing fluidity that estimates a temporal change of a particle position in a target for analysis composed of particles, the method comprising:
determining a velocity of each particle, based on the position of each particle and the particle information of the physical state of each particle in the last time step;
determining the position of each particle in the current time step, based on the velocity determined; and
rearranging each particle in the current time step so that fineness and coarseness in a particle distribution pattern in the target for analysis is reduced, based on a distance between particles arranged at positions determined by means of the position determination unit.

10. A computer program product for causing a computer to estimate a temporal change of a position of a particle in a target for analysis composed of particles, the computer program product causing the computer to function as:
a position determination unit that, based on particle information of a position of each of the particles and a physical state of each particle in a last time step, determines velocity of each particle, and based on the determined velocity, determines a position of each particle in a current time step; and
a rearrangement unit that rearrange each particle in the current time step so that fineness and coarseness in a particle distribution pattern in the target for analysis is reduced, based on a distance between particles arranged at positions determined by means of the position determination unit.
